(19) United States
(12) Patent Application Publication
(10) Pub. No.: US 2025/0158033 A1
(43) Pub. Date: May 15, 2025

(54) LITHIUM METAL SECONDARY BATTERY

(71) Applicant: TOYOTA JIDOSHA KABUSHIKI KAISHA, Toyota-shi (JP)

(72) Inventors: Ryo ASAKURA, Shizuoka-ken (JP); Shinya Shiotani, Nagoya-shi (JP); Sakina Kaneko, Fujisawa-shi (JP)

(73) Assignee: TOYOTA JIDOSHA KABUSHIKI KAISHA, Toyota-shi (JP)

(21) Appl. No.: 18/783,705

(22) Filed: Jul. 25, 2024

(30) Foreign Application Priority Data
Nov. 13, 2023 (JP) 2023-192901

(51) Int. Cl. H01M 4/36; H01M 4/02; H01M 4/40; H01M 10/0525

(52) U.S. Cl. CPC H01M 4/366; H01M 4/405; H01M 10/0525; H01M 2004/027

(57) ABSTRACT

A lithium metal secondary battery has a negative electrode current collector layer, a composite alloy layer, a lithium metal layer, an electrolyte layer, a positive electrode active material layer, and a positive electrode current collector layer in this order, and the composite alloy layer contains a combination of a lithium-gallium alloy and a lithium-tin alloy and/or a lithium-indium alloy.

### CROSS-REFERENCE TO RELATED APPLICATION

This application claims priority to Japanese Patent Application No. 2023-192901 filed on Nov. 13, 2023, incorporated herein by reference in its entirety.

### BACKGROUND

### 1. Technical Field

The present disclosure relates to a lithium metal secondary battery.

### 2. Description of Related Art

In lithium metal secondary batteries, lithium metal having a high ionization tendency among metals is used as a negative electrode active material. Lithium metal secondary batteries are expected to be put into practice because they have a large potential difference between a negative electrode and a positive electrode, provide a high output voltage, and have a high theoretical capacity density, and the following lithium metal secondary batteries have been disclosed.

For example, Japanese Unexamined Patent Application Publication No. 2023-035226 (JP 2023-035226 A) discloses a lithium metal secondary battery having a solid electrolyte layer between a positive electrode and a negative electrode, wherein the negative electrode has a negative electrode current collector and a protective layer, the protective layer contains a metal that can be alloyed with lithium, and the volume capacity density is 1,000 mAh/L or more. According to the lithium metal secondary battery in JP 2023-035226 A, it is possible to improve the durability.

### SUMMARY

Although lithium metal secondary batteries are expected to have excellent battery characteristics, they actually have high resistance and also have a small reversible capacity. Therefore, lithium metal secondary batteries have room for improvement in terms of resistance and reversible capacity.

Here, the present disclosure provides a lithium metal secondary battery in which it is possible to reduce resistance and increase the reversible capacity.

The object of the present disclosure is achieved by the following aspects.

### <Aspect 1>

A lithium metal secondary battery having a negative electrode current collector layer, a composite alloy layer, a lithium metal layer, an electrolyte layer, a positive electrode active material layer, and a positive electrode current collector layer in this order,
wherein the composite alloy layer contains a combination of a lithium-gallium alloy, and a lithium-tin alloy and/or a lithium-indium alloy.

### <Aspect 2>

The lithium metal secondary battery according to Aspect 1,
wherein the composite alloy layer contains a lithium-gallium alloy and a lithium-tin alloy, and
   wherein the atomic percentage of gallium with respect to a total amount of gallium and tin in the composite alloy layer is 10 to 90 atomic %.

### <Aspect 3>

The lithium metal secondary battery according to Aspect 1 or 2,
wherein the composite alloy layer contains a lithium-gallium alloy and a lithium-indium alloy, and
   wherein the atomic percentage of gallium with respect to a total amount of gallium and indium in the composite alloy layer is 10 to 45 atomic %.

According to the lithium metal secondary battery of the present disclosure, it is possible to reduce the resistance and increase the reversible capacity.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic view for illustrating a lithium metal secondary battery of the present disclosure;

FIG. 1B is a schematic view for illustrating the lithium metal secondary battery of the present disclosure;

FIG. 2A is an image showing a surface SEM image of a composite metal layer A3 of Example 3;

FIG. 2B is an image showing the results of EDX mapping analysis of the composite metal layer A3 of Example 3 by surface SEM-EDX for each element (superposition of the elemental oxygen (O), iron (Fe), nickel (Ni), gallium (Ga), and tin (Sn));

FIG. 2C is an image showing the results of EDX mapping analysis of the composite metal layer A3 of Example 3 by surface SEM-EDX for each element (oxygen (O));

FIG. 2D is an image showing the results of EDX mapping analysis of the composite metal layer A3 of Example 3 by surface SEM-EDX for each element (iron (Fe));

FIG. 2E is an image showing the results of EDX mapping analysis of the composite metal layer A3 of Example 3 by surface SEM-EDX for each element (nickel (Ni));

FIG. 2F is an image showing the results of EDX mapping analysis of the composite metal layer A3 of Example 3 by surface SEM-EDX for each element (gallium (Ga));

FIG. 2G is an image showing the results of EDX mapping analysis of the composite metal layer A3 of Example 3 by surface SEM-EDX for each element (tin (Sn));

FIG. 3A is an image showing the results of EDX mapping analysis of a lithium metal secondary battery D3 of Example 3 by cross-sectional SEM-EDX for each element (superposition of the elemental sulfur(S), oxygen (O), iron (Fe), nickel (Ni), gallium (Ga), and tin (Sn));

FIG. 3B is an image showing the results of EDX mapping analysis of the lithium metal secondary battery D3 of Example 3 by cross-sectional SEM-EDX for each element (sulfur(S));

FIG. 3C is an image showing the results of EDX mapping analysis of the lithium metal secondary battery D3 of Example 3 by cross-sectional SEM-EDX for each element (oxygen (O));

FIG. 3D is an image showing the results of EDX mapping analysis of the lithium metal secondary battery D3 of Example 3 by cross-sectional SEM-EDX for each element (iron (Fe));

FIG. 3E is an image showing the results of EDX mapping analysis of the lithium metal secondary battery D3 of Example 3 by cross-sectional SEM-EDX for each element (nickel (Ni));

FIG. 3F is an image showing the results of EDX mapping analysis of the lithium metal secondary battery D3 of Example 3 by cross-sectional SEM-EDX for each element (gallium (Ga));

FIG. 3G is an image showing the results of EDX mapping analysis of the lithium metal secondary battery D3 of Example 3 by cross-sectional SEM-EDX for each element (tin (Sn));

FIG. 4A is an image showing a cross-sectional SEM image of the lithium metal secondary battery D3 of Example 3;

FIG. 4B is a schematic view of a cross-sectional structure of the lithium metal secondary battery D3 of Example 3;

FIG. 5A is an image showing a surface SEM image of a composite metal layer A7 of Example 7;

FIG. 5B is an image showing the results of EDX mapping analysis of the composite metal layer A7 of Example 7 by surface SEM-EDX for each element (superposition of the elemental oxygen (O), gallium (Ga), and indium (In));

FIG. 5C is an image showing the results of EDX mapping analysis of the composite metal layer A7 of Example 7 by surface SEM-EDX for each element (oxygen (O));

FIG. 5D is an image showing the results of EDX mapping analysis of the composite metal layer A7 of Example 7 by surface SEM-EDX for each element (gallium (Ga)); and

FIG. 5E is an image showing the results of EDX mapping analysis of the composite metal layer A7 of Example 7 by surface SEM-EDX for each element (indium (In)).

### DETAILED DESCRIPTION OF EMBODIMENTS

Hereinafter, embodiments of the present disclosure will be described in detail. Here, the present disclosure is not limited to the following embodiments, and various modifications can be performed within the scope of the gist of the present disclosure. In addition, the same components in descriptions of the drawings are denoted with the same reference numerals and redundant descriptions will be omitted.

In the present disclosure, “mixture” indicates a composition, which can constitute a positive electrode active material layer or an electrolyte layer, without change or with other additional components contained. In addition, in the present disclosure, “mixture slurry” indicates a slurry that contains a dispersion medium in addition to a “mixture” and can thereby be applied and dried to form a positive electrode active material layer or an electrolyte layer.

The lithium metal secondary battery of the present disclosure may be a liquid battery containing an electrolytic solution as an electrolyte layer or a solid battery having a solid electrolyte layer as an electrolyte layer. Here, in the present disclosure, “solid battery” indicates a battery in which at least a solid electrolyte is used as an electrolyte, and thus, in the solid battery, a combination of a solid electrolyte and a liquid electrolyte may be used as an electrolyte. In addition, the lithium metal secondary battery of the present disclosure may be an all-solid-state battery, that is, a battery in which only a solid electrolyte is used as an electrolyte.

### Lithium Metal Secondary Battery

A lithium metal secondary battery of the present disclosure has a negative electrode current collector layer, a composite alloy layer, a lithium metal layer, an electrolyte layer, a positive electrode active material layer, and a positive electrode current collector layer in this order, and the composite alloy layer contains a combination of a lithium-gallium alloy and a lithium-tin alloy and/or a lithium-indium alloy.

According to the lithium metal secondary battery of the present disclosure, it is possible to reduce the resistance and increase the reversible capacity.

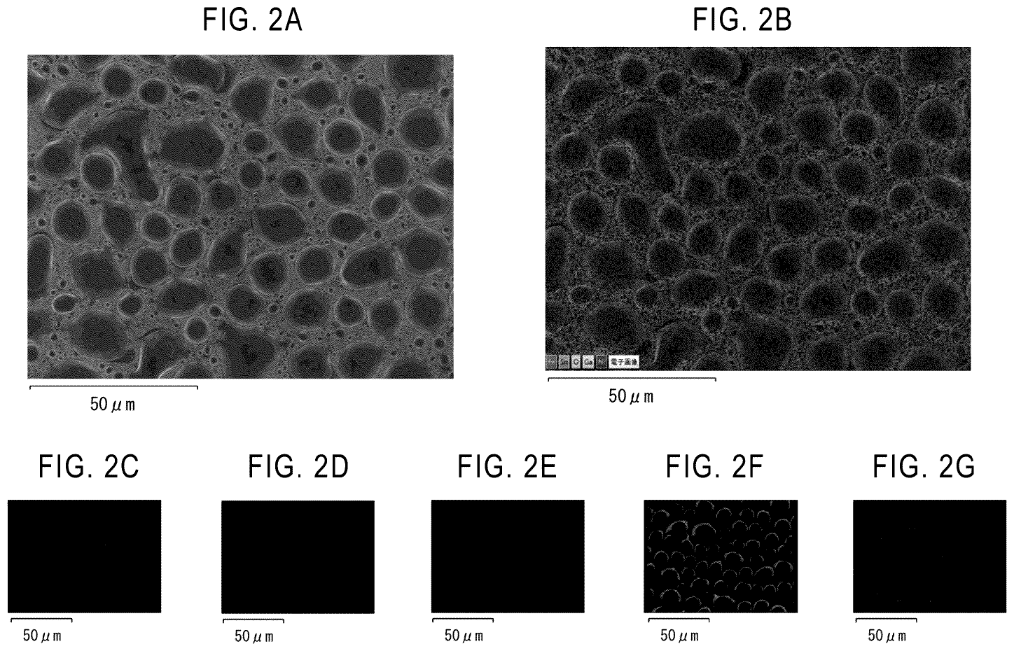

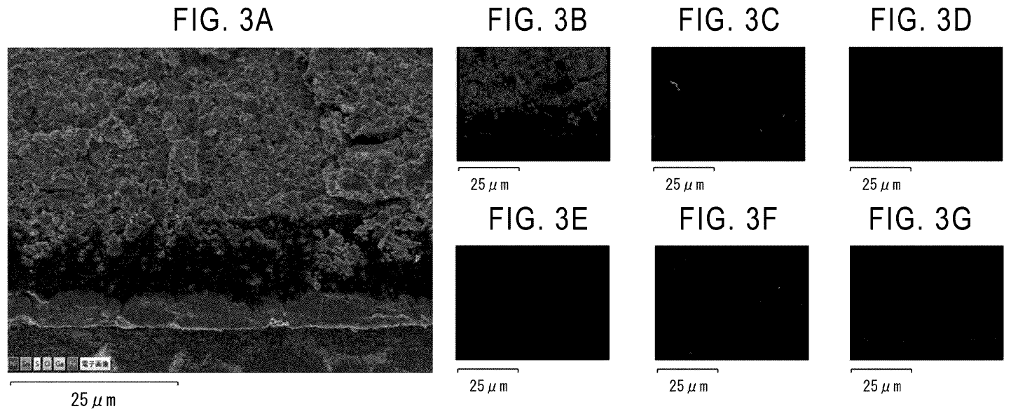

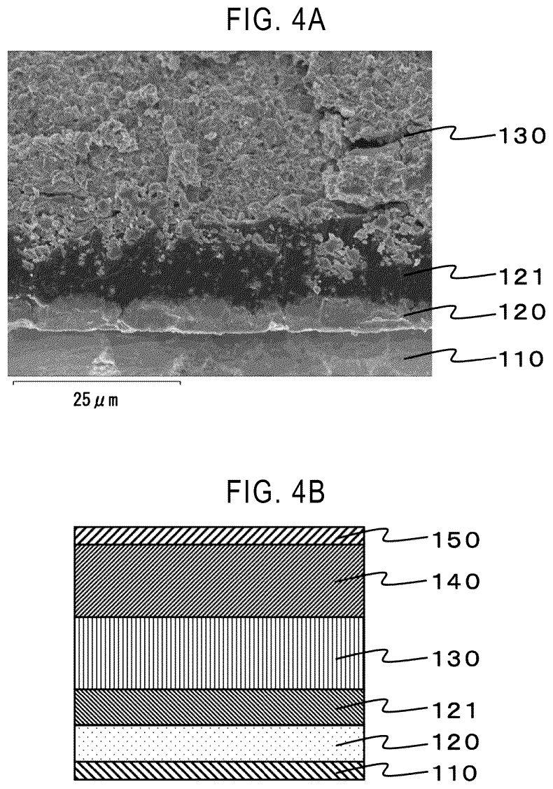

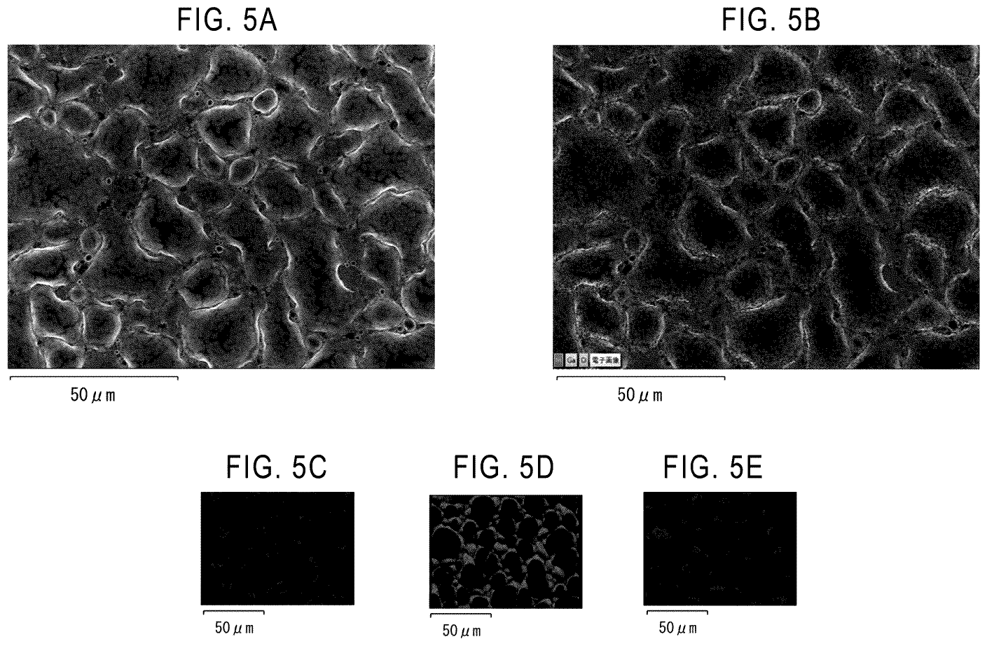

In the present disclosure, the composite alloy layer is not particularly limited, and it can be formed from a composite metal layer containing a combination of gallium and tin and/or indium. For example, specifically, as shown in FIG. 2A, FIG. 2B, FIG. 2C, FIG. 2D, FIG. 2E, FIG. 2F, FIG. 2G, FIG. 5A, FIG. 5B, FIG. 5C, FIG. 5D, and FIG. 5E, in the composite metal layer, a composite in which gallium surrounds tin particles or indium particles is formed. When a charging operation is performed on the lithium metal secondary battery having a composite metal layer, gallium in the composite metal layer and tin and/or indium are reacted with lithium transferred from the positive electrode active material layer retaining lithium, each metal in the composite metal layer is alloyed with lithium, and thereby a composite alloy layer containing a composite of a lithium-gallium alloy and a lithium-tin alloy and/or a lithium-indium alloy can be formed.

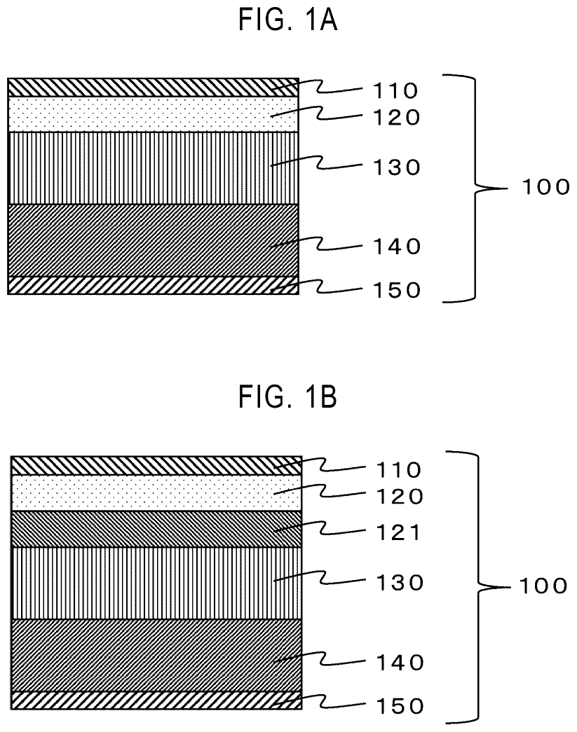

While not being bound by this theory, specifically, for example, as shown in FIG. 1A and FIG. 1B, it is speculated that, when the composite alloy layer 120 containing the composite is formed near the negative electrode current collector layer 110, interfacial peeling between the electrolyte layer 130 and the lithium metal layer 121 during lithium desorption is restricted, and thereby it is possible to reduce the resistance and increase the reversible capacity.

### Configuration of Lithium Metal Secondary Battery

The lithium metal secondary battery of the present disclosure has a negative electrode current collector layer, a composite alloy layer, a lithium metal layer, an electrolyte layer, a positive electrode active material layer, and a positive electrode current collector layer in this order.

### Negative Electrode Current Collector Layer

The material used in the negative electrode current collector layer is not particularly limited, and those generally used as negative electrode current collectors for lithium metal secondary batteries can be appropriately used. Examples of materials used for negative electrode current collector layers include Cu, Ni, Cr, Au, Pt, Ag, Al, Fe, Ti, Zn, Co, stainless steel, and carbon sheets, but the present disclosure is not limited thereto. In particular, in order to secure the reduction resistance and in order to prevent it from alloying with lithium, the material used in the negative electrode current collector layer may contain at least one metal selected from among Cu, Ni, and stainless steel, and may be formed of carbon sheets. The negative electrode current collector layer may have some coating layers on the surface thereof in order to adjust the resistance or the like.

The shape of the negative electrode current collector layer is not particularly limited, and examples thereof include a foil shape, a plate shape and a mesh shape. Among these, a foil shape is preferable.

The thickness of the negative electrode current collector layer is not particularly limited, and may be 0.1 μm or more or 1 μm or more, and may be 1 mm or less or 100 μm or less.

### Composite Alloy Layer

The composite alloy layer of the lithium metal secondary battery of the present disclosure contains a combination of a lithium-gallium alloy and a lithium-tin alloy and/or a lithium-indium alloy.

### Composite Alloy Layer: Lithium-Gallium Alloy/Lithium-Tin Alloy Layer

The composite alloy layer of the lithium metal secondary battery of the present disclosure may contain a lithium-gallium alloy and a lithium-tin alloy.

The atomic percentage of gallium with respect to a total amount of gallium and tin in the composite alloy layer is not particularly limited, and may be 10 to 90 atomic %. The atomic percentage is not particularly limited, and may be 5 atomic % or more, 10 atomic % or more, 20 atomic % or more, 30 atomic % or more, 40 atomic % or more, 50 atomic % or more, or 60 atomic % or more, and may be 95 atomic % or less, 90 atomic % or less, 85 atomic % or less, or 80 atomic % or less.

The composite alloy layer may further contain a metal other than gallium, tin, and lithium. The metal other than gallium, tin, and lithium is not particularly limited, and the percentage thereof in the composite alloy layer may be 0 atomic % or more, 1 atomic % or more, 3 atomic % or more, or 5 atomic % or more, and may be 50 atomic % or less, 20 atomic % or less, or 10 atomic % or less.

### Composite Alloy Layer: Lithium-Gallium Alloy/Lithium-Indium Alloy Layer

The composite alloy layer of the lithium metal secondary battery of the present disclosure may contain a lithium-gallium alloy and a lithium-indium alloy.

The atomic percentage of gallium with respect to a total amount of gallium and indium in the composite alloy layer is not particularly limited, and may be 10 to 45 atomic %. The atomic percentage is not particularly limited, and may be 5 atomic % or more, 10 atomic % or more, 15 atomic % or more, 20 atomic % or more, 25 atomic % or more, 30 atomic % or more, 35 atomic % or more, or 40 atomic % or more, and may be 90 atomic % or less, 80 atomic % or less, 70 atomic % or less, 60 atomic % or less, 50 atomic % or less, or 45 atomic % or less.

The composite alloy layer may further contain a metal other than gallium, indium, and lithium. The metal other than gallium, indium, and lithium is not particularly limited, and the percentage thereof in the composite alloy layer may be 0 atomic % or more, 1 atomic % or more, 3 atomic % or more, or 5 atomic % or more, and may be 50 atomic % or less, 20 atomic % or less, or 10 atomic % or less.

The thickness of the composite alloy layer is not particularly limited, and may be 0.1 μm or more, 0.2 μm or more, 0.5 μm or more, or 1.0 μm or more, and may be 5.0 μm or less, 4.0 μm or less, 3.0 μm or less, or 2.0 μm or less in a fully charged state.

The composite alloy layer is not particularly limited, and it can be easily formed from a composite metal layer containing a combination of gallium and tin and/or indium. Specifically, when a charging operation is performed on the lithium metal secondary battery having a composite metal layer, gallium in the composite metal layer and tin and/or indium are reacted with lithium transferred from the positive electrode active material layer retaining lithium, each metal in the composite metal layer is alloyed with lithium, and thereby a composite alloy layer containing a composite of a lithium-gallium alloy and a lithium-tin alloy and/or a lithium-indium alloy can be formed.

In addition, the composite metal layer can be easily formed, for example, on the negative electrode current collector by a two-dimensional vapor deposition method using an ion plating method, but the present disclosure is not limited thereto.

### Lithium Metal Layer

The lithium metal secondary battery of the present disclosure has a lithium metal layer. The lithium metal layer functions as a negative electrode active material layer in the lithium metal secondary battery of the present disclosure.

Here, since the lithium metal layer functions as a “negative electrode active material layer,” a lithium metal layer exists as a “negative electrode active material layer” in a charged state, but in a discharged state, lithium metal is transferred as lithium ions to the positive electrode active material layer, and the lithium metal layer as a “negative electrode active material layer” may no longer exist.

The shape of the lithium metal layer is not particularly limited, and may be, for example, a sheet-like lithium metal layer having a substantially flat surface. The thickness of the lithium metal layer is not particularly limited, and may be, for example, 0.1 μm or more, 1 μm or more, or 10 μm or more and may be 2 mm or less, 1 mm or less, or 500 μm or less in a fully charged state.

### Electrolyte Layer

### Electrolyte Layer-Solid Electrolyte Layer

The lithium metal secondary battery of the present disclosure may be a solid battery, that is, can have a solid electrolyte layer as an electrolyte layer.

The solid electrolyte layer contains a solid electrolyte, and as necessary, a binder and the like.

### Solid Electrolyte

The material of the solid electrolyte is not particularly limited, and may be, for example, a sulfide solid electrolyte, an oxide solid electrolyte, or a polymer electrolyte.

Examples of sulfide solid electrolytes include sulfide-based amorphous solid electrolytes, sulfide-based crystalline solid electrolytes, and argyrodite type solid electrolytes, but the present disclosure is not limited thereto. Specific examples of sulfide solid electrolytes include Li₂S—P₂S₅ types (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ and the like; and combinations thereof, but the present disclosure is not limited thereto.

Examples of oxide solid electrolytes include Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ(LiPON), but the present disclosure is not limited thereto.

The sulfide solid electrolyte and the oxide solid electrolyte may be glass or crystallized glass (glass ceramics).

Examples of polymer electrolytes include polyethylene oxide (PEO), polypropylene oxide (PPO), and copolymers thereof, but the present disclosure is not limited thereto.

### Binder

The binder is not particularly limited. The binder may be a material, for example, polyvinylidene fluoride (PVdF), butadiene rubber (BR), polytetrafluoroethylene (PTFE), or styrene-butadiene rubber (SBR), but the present disclosure is not limited thereto. The binder is not particularly limited, only one type may be used alone or two or more types thereof may be used in combination.

The thickness of the solid electrolyte layer is not particularly limited, and may be, for example, 0.1 μm or more, 1 μm or more, or 10 μm or more, and may be 2 mm or less, 1 mm or less, or 500 μm or less.

The solid electrolyte layer can be easily formed, for example, by dry or wet molding an electrolyte mixture containing the above solid electrolyte, binder and the like.

### Electrolyte Layer-Separator Layer

The lithium metal secondary battery of the present disclosure may be a liquid battery, that is, can contain an electrolytic solution as an electrolyte layer, particularly an electrolytic solution held in a separator layer.

### Electrolytic Solution

The electrolytic solution is not particularly limited, and it preferably contains a supporting salt and a solvent.

The supporting salt (lithium salt) of the electrolytic solution having lithium ion conductivity is not particularly limited, and examples thereof include inorganic lithium salts and organic lithium salts. Examples of inorganic lithium salts include LiPF₆, LiBF₄, LiClO₄, and LiAsF₆, but the present disclosure is not limited thereto. Examples of organic lithium salts include LiCF₃SO₃, LiN(CF₃SO₂)₂, LiN(C₂F₅SO₂)₂, LIN(FSO₂)₂, and LiC(CF₃SO₂)₃, but the present disclosure it not limited thereto.

The solvent used in the electrolytic solution is not particularly limited, and examples thereof include cyclic carbonates and chain carbonates. Examples of cyclic carbonates include ethylene carbonate (EC), propylene carbonate (PC), and butylene carbonate (BC), but the present disclosure is not limited thereto. Examples of chain carbonates include dimethyl carbonate (DMC), diethyl carbonate (DEC), and ethyl methyl carbonate (EMC), but the present disclosure is not limited thereto. The electrolytic solution is not particularly limited, and only one type may be used alone or two or more types thereof may be used in combination.

### Separator

The separator is not particularly limited, and those generally used as separators for lithium metal secondary batteries can be appropriately used. As the separator, for example, polyolefin-based, polyamide-based, and polyimide-based non-woven fabrics can be used.

### Positive Electrode Active Material Layer

The positive electrode active material layer contains at least a positive electrode active material, and may further optionally contain a conductivity aid, a solid electrolyte, a binder and the like. The positive electrode active material layer may additionally contain various additives. The contents of the positive electrode active material, the conductivity aid, the binder and the like in the positive electrode active material layer may be appropriately determined according to desired battery performance. For example, based on 100 mass % of the entire positive electrode active material layer (total solid content), the content of the positive electrode active material may be 40 mass % or more, 50 mass % or more, or 60 mass % or more, and may be 100 mass % or less, or 90 mass % or less.

### Positive Electrode Active Material

The material of the positive electrode active material is not particularly limited as long as it can absorb and release lithium ions. For example, the positive electrode active material may be lithium cobaltate (LiCoO₂), lithium nickelate (LiNiO₂), lithium manganate (LiMn₂O₄), nickel/cobalt/lithium manganate (NCM), LiCO_{1/3}Ni_{1/3}Mn_{1/3}O₂, nickel/cobalt/lithium aluminate (NCA; LiNiₓCo_{y}Al_{z}O₂), a hetero-element substituted Li—Mn spinel of a composition represented by Li₁₊ₓMn_{2-x-y}M_{y}O₄ (M is one or more metal elements selected from among Al, Mg, Co, Fe, Ni, and Zn), or the like, but the present disclosure is not limited thereto.

The positive electrode active material is not particularly limited, and may have a coating layer. The coating layer is a layer containing a substance which has lithium ion conductivity, has low reactivity with the positive electrode active material and the solid electrolyte, and can maintain the form of the coating layer that does not flow when in contact with the active material or the solid electrolyte. Specific examples of materials constituting the coating layer include Li₄Ti₅O₁₂ and Li₃PO₄ in addition to LiNbO₃, but the present disclosure is not limited thereto.

The shape of the positive electrode active material is not particularly limited as long as it is a general shape for the positive electrode active material of a lithium metal secondary battery. The positive electrode active material may be, for example, in the form of particles. The positive electrode active material may be primary particles or secondary particles in which a plurality of primary particles is aggregated. The average particle diameter D₅₀ of the positive electrode active material may be, for example, 1 nm or more, 5 nm or more, or 10 nm or more, and may be 500 μm or less, 100 μm or less, 50 μm or less, or 30 μm or less. Here, the average particle diameter D₅₀ is a particle diameter (median diameter) at a cumulative value of 50% in the volume-based particle size distribution obtained by a laser diffraction/scattering method.

### Conductivity Aid

The conductivity aid is not particularly limited. The conductivity aid may be, for example, vapor grown carbon fibers (VGCF), acetylene black (AB), Ketjen black (KB), carbon nanotubes (CNT), carbon nanofibers (CNF) or the like, but the present disclosure is not limited thereto. The conductivity aid may be, for example, in the form of particles or fibers, and its size is not particularly limited. The conductivity aid is not particularly limited, and only one type may be used alone or two or more types thereof may be used in combination.

For the solid electrolyte and the binder, the above description “<Electrolyte layer-solid electrolyte layer>” can be referred to.

The shape of the positive electrode active material layer is not particularly limited, and may be, for example, a sheet-like positive electrode active material layer having a substantially flat surface. The thickness of the positive electrode active material layer is not particularly limited, and may be, for example, 0.1 μm or more, 1 μm or more, or 10 μm or more, and may be 2 mm or less, 1 mm or less, or 500 μm or less.

### Positive Electrode Current Collector Layer

The material used in the positive electrode current collector layer is not particularly limited, and those generally used as positive electrode current collectors for lithium metal secondary batteries can be appropriately used. Examples of materials used for the positive electrode current collector layer include Cu, Ni, Cr, Au, Pt, Ag, Al, Fe, Ti, Zn, Co, and stainless steel, but the present disclosure is not limited thereto. In addition, the positive electrode current collector layer may have some coating layers on the surface thereof in order to adjust the resistance or the like. In addition, the positive electrode current collector layer may be a layer in which the above metal is plated or vapor-deposited on a metal foil or a substrate.

The shape of the positive electrode current collector layer is not particularly limited, and examples thereof include a foil shape, a plate shape, and a mesh shape. Among these, a foil shape is preferable.

The thickness of the positive electrode current collector layer is not particularly limited, and may be 0.1 μm or more or 1 μm or more and 1 mm or less or 100 μm or less.

The positive electrode active material layer can be produced by applying a known method. For example, the positive electrode active material layer can be easily molded by dry or wet molding a positive electrode mixture containing various components described above. The positive electrode active material layer may be molded together with the positive electrode current collector layer or may be molded separately from the positive electrode current collector layer.

FIG. 1A and FIG. 1B are schematic views showing one embodiment of the lithium metal secondary battery of the present disclosure, but the present disclosure is not limited thereto.

As shown in FIG. 1A, in a discharged state, a lithium metal secondary battery 100 may be a battery in which a negative electrode current collector layer 110, a composite alloy layer 120, an electrolyte layer 130, a positive electrode active material layer 140, and a positive electrode current collector layer 150 are laminated in this order, and a lithium metal layer 121 may not be present. As shown in FIG. 1B, in a charged state, the lithium metal secondary battery 100 is a battery in which the negative electrode current collector layer 110, the composite alloy layer 120, the lithium metal layer 121, the electrolyte layer 130, the positive electrode active material layer 140, and the positive electrode current collector layer 150 are laminated in this order, and the lithium metal layer 121 is present as a negative electrode active material layer. The composite alloy layer 120 contains a combination of a lithium-gallium alloy and a lithium-tin alloy and/or a lithium-indium alloy. When the composite alloy layer 120 is formed near the negative electrode current collector layer 110, interfacial peeling between the electrolyte layer 130 and the lithium metal layer 121 during lithium desorption is restricted, and thereby it is possible to reduce the resistance and increase the reversible capacity.

For the lithium metal secondary battery of the present disclosure, for example, a laminate in which a negative electrode current collector layer, a composite metal layer, an electrolyte layer, a positive electrode active material layer, and a positive electrode current collector layer are laminated in this order is produced, this laminate is accommodated in a laminate film, vacuum-sealed, and pressed to produce a preliminary lithium metal secondary battery, and when a charging operation is performed on this preliminary lithium metal secondary battery, each metal contained in the composite metal layer is reacted and alloyed with lithium transferred from the positive electrode active material, and thereby a composite alloy layer can be formed to obtain a lithium metal secondary battery, but the present disclosure is not limited thereto.

Examples of shapes of the lithium metal secondary battery include a coin shape, a laminate shape, a cylindrical shape, and a rectangular shape, but the present disclosure is not limited thereto.

The present disclosure will be described in more detail with reference to the following examples, but the scope of the present disclosure is not limited to these examples.

### Example 1

### Production of Composite Metal Layer A1

A composite metal layer containing gallium and tin was formed on a stainless steel (SUS) foil as a negative electrode current collector at a thickness of 1.0 μm by binary vapor deposition using an ion plating method, and a composite metal layer A1 formed on the SUS foil was produced. In this case, the layer was produced so that the atomic percentage of gallium with respect to a total amount of gallium and tin was 10 atomic %. The atomic percentage of gallium with respect to a total amount of gallium and tin of the obtained composite metal layer A1 was 13 atomic %.

### Production of Electrolyte Layer B1

A sulfide solid electrolyte (92.6 parts by mass) as a solid electrolyte, a binder (7.4 parts by mass), and an appropriate amount of butyl acetate as a dispersion medium were mixed to prepare an electrolyte mixture slurry. The obtained electrolyte mixture slurry was applied onto a release film with a coating gap of 325 μm. Next, the slurry was preliminarily dried at room temperature for 3 hours and mainly dried at 165° C. for 1 hour. Two sheets of the coating film after main drying were punched out at @14.50 mm and superimposed so that respective coating surfaces faced each other, and pressed at 7 tons, and the release film was peeled off to produce a self-supporting electrolyte layer B1.

### Production of Positive Electrode Active Material Layer C1

Nickel/cobalt/lithium aluminate (NCA) (84.7 parts by mass) as a positive electrode active material, a sulfide solid electrolyte (13.4 parts by mass) as a solid electrolyte, a binder (0.6 parts by mass), a conductivity aid (1.3 parts by mass), and an appropriate amount of butyl butyrate as a dispersion medium were mixed to prepare a positive electrode mixture slurry. The obtained positive electrode mixture slurry was applied onto an aluminum (A1) foil as a positive electrode current collector with a coating gap of 225 μm, and preliminarily dried at 60° C. and mainly dried at 165° C. for 1 hour to produce a positive electrode active material layer C1 formed on the A1 foil. The design capacity of the positive electrode active material layer C1 was 3.0 mAh/cm² and the basis weight thereof was 18.7 mg/cm².

### Production of Preliminary Lithium Metal Secondary Battery

The composite metal layer A1 was punched out at φ14.50 mm, and the positive electrode active material layer C1 was punched out at φ11.28 mm. The electrolyte layer B1 was arranged between the composite metal layer A1 and the positive electrode active material layer C1, and the negative electrode current collector layer, the composite metal layer A1, the electrolyte layer B1, the positive electrode active material layer C1, and the positive electrode current collector layer were laminated in this order to produce a laminate. Next, this laminate was accommodated in a laminate film, vacuum-sealed, and cold-isostatically pressed in an isostatic press of 392 MPa to produce a preliminary lithium metal secondary battery. Here, aluminum (A1) was used for a positive electrode tab, and nickel (Ni) was used for a negative electrode tab.

### Formation and Electrochemical Evaluation of Lithium Metal Secondary Battery D1: First Cycle Reversible Capacity

The preliminary lithium metal secondary battery was restrained at 1 MPa using a constant pressure tool with a spring inserted so that the restraint pressure was constant. Next, the preliminary lithium metal secondary battery was left in a thermostatic tank at 60° C., and a constant current (current density: 0.15 mA/cm², equivalent to 0.05 C)−constant voltage (cutoff current density: 0.03 mA/cm², equivalent to 0.01 C) test was performed at 60° C. in a cutoff voltage range of 4.2 V-3.0 V. When a charging operation was performed on the preliminary lithium metal secondary battery, gallium and tin contained in the composite metal layer A1 were reacted with lithium transferred from the positive electrode active material layer, gallium and tin were alloyed with lithium, and thereby a composite alloy layer was formed to obtain a lithium metal secondary battery D1. The first cycle reversible capacity of the lithium metal secondary battery D1 was 2.37 mAh/cm².

Electrochemical Measurement of Lithium Metal Secondary Battery D1: Resistance after First Charging and Discharging

After the first charging and discharging at 60° C., the resistance of the lithium metal secondary battery D1 was measured by an AC impedance method. The resistance of the lithium metal secondary battery D1 was 108 Ωcm².

### Example 2

### Production of Composite Metal Layer A2

A composite metal layer A2 formed on a SUS foil was produced in the same method as in Example 1 except that the atomic percentage of gallium with respect to a total amount of gallium and tin was 20 atomic %. The atomic percentage of gallium with respect to a total amount of gallium and tin of the obtained composite metal layer A2 was 25 atomic %.

### Production and Electrochemical Measurement of Lithium Metal Secondary Battery D2

A lithium metal secondary battery D2 was produced in the same method as in Example 1 except that the composite metal layer A2 was used in place of the composite metal layer A1. Electrochemical measurement of the lithium metal secondary battery D2 was performed in the same method as in Example 1. Table 1 shows the first cycle reversible capacity and the resistance after first charging and discharging of the lithium metal secondary battery D2.

### Example 3

### Production of Composite Metal Layer A3

A composite metal layer A3 formed on a SUS foil was produced in the same method as in Example 1 except that the atomic percentage of gallium with respect to a total amount of gallium and tin was 50 atomic %. The atomic percentage of gallium with respect to a total amount of gallium and tin of the obtained composite metal layer A3 was 44 atomic %.

### Surface SEM-EDX Observation of Composite Metal Layer A3

The surface of the composite metal layer A3 was observed under a scanning electron microscope (SEM) using a secondary electron image at an applied voltage of 5 kV and element mapping was performed through energy dispersive X-ray analysis (EDX).

### Production and Electrochemical Measurement of Lithium Metal Secondary Battery D3

A lithium metal secondary battery D3 was produced in the same method as in Example 1 except that the composite metal layer A3 was used in place of the composite metal layer A1. Electrochemical measurement of the lithium metal secondary battery D3 was performed in the same method as in Example 1. Table 1 shows the first cycle reversible capacity and the resistance after first charging and discharging of the lithium metal secondary battery D3.

### Cross-Sectional SEM-EDX Observation of Lithium Metal Secondary Battery D3

The cross section of the charged lithium metal secondary battery D3 was observed under a scanning electron microscope (SEM) using a secondary electron image at an applied voltage of 5 kV and element mapping was performed through energy dispersive X-ray analysis (EDX).

### Example 4

### Production of Composite Metal Layer A4

A composite metal layer A4 formed on a SUS foil was produced in the same method as in Example 1 except that the atomic percentage of gallium with respect to a total amount of gallium and tin was 80 atomic %. The atomic percentage of gallium with respect to a total amount of gallium and tin of the obtained composite metal layer A4 was 75 atomic %.

### Production and Electrochemical Measurement of Lithium Metal Secondary Battery D4

A lithium metal secondary battery D4 was produced in the same method as in Example 1 except that the composite metal layer A4 was used in place of the composite metal layer A1. Electrochemical measurement of the lithium metal secondary battery D4 was performed in the same method as in Example 1. Table 1 shows the first cycle reversible capacity and the resistance after first charging and discharging of the lithium metal secondary battery D4.

### Comparative Example 1

### Production of Composite Metal Layer a1

A composite metal layer a1 formed on a SUS foil was produced in the same method as in Example 1 except that the atomic percentage of gallium with respect to a total amount of gallium and tin was 0 atomic %, that is, it was produced using only tin. The atomic percentage of gallium with respect to a total amount of gallium and tin of the obtained composite metal layer a1 was 0 atomic %.

### Production and Electrochemical Measurement of Lithium Metal Secondary Battery d1

A lithium metal secondary battery d1 was produced in the same method as in Example 1 except that the composite metal layer a1 was used in place of the composite metal layer A1. Electrochemical measurement of the lithium metal secondary battery d1 was performed in the same method as in Example 1. Table 1 shows the first cycle reversible capacity and the resistance after first charging and discharging of the lithium metal secondary battery d1.

### Comparative Example 2

### Production of Composite Metal Layer a2

A composite metal layer a2 formed on a SUS foil was produced in the same method as in Example 1 except that the atomic percentage of gallium with respect to a total amount of gallium and tin was 100 atomic %, that is, it was produced using only gallium. The atomic percentage of gallium with respect to a total amount of gallium and tin of the obtained composite metal layer a2 was 100 atomic %.

### Production and Electrochemical Measurement of Lithium Metal Secondary Battery d2

A lithium metal secondary battery d2 was produced in the same method as in Example 1 except that the composite metal layer a2 was used in place of the composite metal layer A1. Electrochemical measurement of the lithium metal secondary battery d2 was performed in the same method as in Example 1. Table 1 shows the first cycle reversible capacity and the resistance after first charging and discharging of the lithium metal secondary battery d2.

Table 1 shows the electrochemical measurement evaluation results of Examples 1 to 4 and Comparative Examples 1 and 2.

TABLE 1

| | | Example | Example | Example | Example | Comparative | Comparative |
|---|---|---|---|---|---|---|---|
| | | 1 | 2 | 3 | 4 | Example 1 | Example 2 |
| Composite metal layer | | Composite | Composite | Composite | Composite | Composite | Composite |
| (composite metal layer of | | metal | metal | metal | metal | metal | metal |
| gallium and tin) | | layer A1 | layer A2 | layer A3 | layer A4 | layer a1 | layer a2 |
| Alloy | Atomic | 13 | 25 | 44 | 75 | 0 | 100 |
| composition | percentage | | | | | | |
| | of gallium | | | | | | |
| | with respect | | | | | | |
| | to a total | | | | | | |
| | amount of | | | | | | |
| | gallium and | | | | | | |
| | tin [atomic %] | | | | | | |
| Electrolyte layer | | Electrolyte | Electrolyte | Electrolyte | Electrolyte | Electrolyte | Electrolyte |
| | | layer B1 | layer B1 | layer B1 | layer B1 | layer B1 | layer B1 |
| Electrolyte | Sulfide solid | 92.6 | 92.6 | 92.6 | 92.6 | 92.6 | 92.6 |
| mixture | electrolyte | | | | | | |
| | Binder | 7.4 | 7.4 | 7.4 | 7.4 | 7.4 | 7.4 |
| Positive electrode | | Positive | Positive | Positive | Positive | Positive | Positive |
| active material layer | | electrode | electrode | electrode | electrode | electrode | electrode |
| | | active | active | active | active | active | active |
| | | material | material | material | material | material | material |
| | | layer C1 | layer C1 | layer C1 | layer C1 | layer C1 | layer C1 |
| Positive | Positive | 84.7 | 84.7 | 84.7 | 84.7 | 84.7 | 84.7 |
| electrode | electrode | | | | | | |
| mixture | active | | | | | | |
| | material (NCA) | | | | | | |
| | Sulfide solid | 13.4 | 13.4 | 13.4 | 13.4 | 13.4 | 13.4 |
| | electrolyte | | | | | | |
| | Binder | 0.6 | 0.6 | 0.6 | 0.6 | 0.6 | 0.6 |
| | Conductivity | 1.3 | 1.3 | 1.3 | 1.3 | 1.3 | 1.3 |
| | aid | | | | | | |
| Lithium metal | | Lithium | Lithium | Lithium | Lithium | Lithium | Lithium |
| secondary battery | | metal | metal | metal | metal | metal | metal |
| | | secondary | secondary | secondary | secondary | secondary | secondary |
| | | battery D1 | battery D2 | battery D3 | battery D4 | battery d1 | battery d2 |
| Evaluation | First cycle | 2.37 | 2.45 | 2.50 | 2.84 | 2.38 | 2.08 |
| results | reversible | | | | | | |
| | capacity | | | | | | |
| | [mAh/cm²] | | | | | | |
| | Resistance | 108 | 66 | 70 | 181 | 617 | 298 |
| | after first | | | | | | |
| | charging and | | | | | | |
| | discharging | | | | | | |
| | [Ωcm²] | | | | | | |

According to the surface SEM-EDX observation of the composite metal layer A3, a composite in which gallium surrounded tin particles was formed. In addition, from cross-sectional SEM-EDX of the lithium metal secondary battery D3, in the composite metal layer A3, during lithium insertion in the first charge, lithium-gallium and lithium-tin composite metal layers were formed near the negative electrode current collector layer.

In Examples 1 to 4, regarding the first cycle reversible capacity at 60° C., the lithium metal secondary battery D4 having a composite alloy layer containing a lithium-gallium alloy and a lithium-tin alloy formed from the composite metal layer A4 (Example 4) exhibited the highest value (2.50 mAh/cm²). When the composite metal layers A2 and A3 (Examples 2 and 3) were used, improvement in the first cycle reversible capacity was observed compared to when tin was used alone or gallium was used alone. In addition, regarding the resistance after first charging and discharging at 60° C., the lithium metal secondary batteries D1 to D4 having a composite alloy layer formed from the composite metal layers A1 to A4 had a lower resistance than the lithium metal secondary batteries d1 and d2 having a composite alloy layer formed from the composite metal layers a1 and a2 in which tin was used alone or gallium was used alone.

It was speculated that, when a composite alloy layer formed from a composite metal layer containing a composite formed such that gallium surrounded tin particles was formed near the negative electrode current collector layer, interfacial peeling between the electrolyte layer and the lithium metal layer during lithium desorption was restricted, and thereby the resistance was reduced, and the reversible capacity increased.

### Example 5

### Production of Composite Metal Layer A5

A composite metal layer containing gallium and indium was formed on a stainless steel (SUS) foil as a negative electrode current collector at a thickness of 1.0 μm by binary vapor deposition using an ion plating method, and a composite metal layer A5 formed on the SUS foil was produced. In this case, the layer was produced so that the atomic percentage of gallium with respect to a total amount of gallium and indium was 10 atomic %. The atomic percentage of gallium with respect to a total amount of gallium and indium of the obtained composite metal layer A5 was 15 atomic %.

### Production and Electrochemical Measurement of Lithium Metal Secondary Battery D5

A lithium metal secondary battery D5 was produced in the same method as in Example 1 except that the composite metal layer A5 was used in place of the composite metal layer A1. Electrochemical measurement of the lithium metal secondary battery D5 was performed in the same method as in Example 1. Table 2 shows the first cycle reversible capacity and the resistance after first charging and discharging of the lithium metal secondary battery D5.

### Example 6

### Production of Composite Metal Layer A6

A composite metal layer A6 formed on a SUS foil was produced in the same method as in Example 5 except that the atomic percentage of gallium with respect to a total amount of gallium and indium was 20 atomic %. The atomic percentage of gallium with respect to a total amount of gallium and indium of the obtained composite metal layer A6 was 25 atomic %.

### Production and Electrochemical Measurement of Lithium Metal Secondary Battery D6

A lithium metal secondary battery D6 was produced in the same method as in Example 1 except that the composite metal layer A6 was used in place of the composite metal layer A1. Electrochemical measurement of the lithium metal secondary battery D6 was performed in the same method as in Example 1. Table 2 shows the first cycle reversible capacity and the resistance after first charging and discharging of the lithium metal secondary battery D6.

### Example 7

### Production of Composite Metal Layer A7

A composite metal layer A7 formed on a SUS foil was produced in the same method as in Example 5 except that the atomic percentage of gallium with respect to a total amount of gallium and indium was 50 atomic %. The atomic percentage of gallium with respect to a total amount of gallium and indium of the obtained composite metal layer A7 was 43 atomic %.

### Surface SEM-EDX Observation of Composite Metal Layer A7

The surface of the composite metal layer A7 was observed under a scanning electron microscope (SEM) using a secondary electron image at an applied voltage of 5 kV and element mapping was performed through energy dispersive X-ray analysis (EDX).

### Production and Electrochemical Measurement of Lithium Metal Secondary Battery D7

A lithium metal secondary battery D7 was produced in the same method as in Example 1 except that the composite metal layer A7 was used in place of the composite metal layer A1. Electrochemical measurement of the lithium metal secondary battery D7 was performed in the same method as in Example 1. Table 2 shows the first cycle reversible capacity and the resistance after first charging and discharging of the lithium metal secondary battery D7.

### Comparative Example 3

### Production of Composite Metal Layer a3

A composite metal layer a3 formed on a SUS foil was produced in the same method as in Example 5 except that the atomic percentage of gallium with respect to a total amount of gallium and indium was 0 atomic %, that is, it was produced using only indium. The atomic percentage of gallium with respect to a total amount of gallium and indium of the obtained composite metal layer a3 was 0 atomic %.

### Production and Electrochemical Measurement of Lithium Metal Secondary Battery d3

A lithium metal secondary battery d3 was produced in the same method as in Example 1 except that the composite metal layer a3 was used in place of the composite metal layer A1. Electrochemical measurement of the lithium metal secondary battery d3 was performed in the same method as in Example 1. Table 2 shows the first cycle reversible capacity and the resistance after first charging and discharging of the lithium metal secondary battery d3.

Table 2 shows the electrochemical measurement evaluation results of Examples 5 to 7 and Comparative Examples 2 and 3.

TABLE 2

| | | | | | Comparative | Comparative |
|---|---|---|---|---|---|---|
| | | Example 5 | Example 6 | Example 7 | Example 2 | Example 3 |
| Composite metal layer | | Composite | Composite | Composite | Composite | Composite |
| (composite metal layer of | | metal layer | metal layer | metal layer | metal layer | metal layer |
| gallium and indium) | | A5 | A6 | A7 | a2 | a3 |
| Alloy | Atomic | 15 | 25 | 43 | 100 | 0 |
| composition | percentage | | | | | |
| | of gallium | | | | | |
| | with respect | | | | | |
| | to a total | | | | | |
| | amount of | | | | | |
| | gallium and | | | | | |
| | indium | | | | | |
| | [atomic %] | | | | | |
| Electrolyte layer | | Electrolyte | Electrolyte | Electrolyte | Electrolyte | Electrolyte |
| | | layer B1 | layer B1 | layer B1 | layer B1 | layer B1 |
| Electrolyte | Sulfide solid | 92.6 | 92.6 | 92.6 | 92.6 | 92.6 |
| mixture | electrolyte | | | | | |
| | Binder | 7.4 | 7.4 | 7.4 | 7.4 | 7.4 |
| Positive electrode | | Positive | Positive | Positive | Positive | Positive |
| active material layer | | electrode | electrode | electrode | electrode | electrode |
| | | active | active | active | active | active |
| | | material | material | material | material | material |
| | | layer C1 | layer C1 | layer C1 | layer C1 | layer C1 |
| Positive | Positive | 84.7 | 84.7 | 84.7 | 84.7 | 84.7 |
| electrode | electrode | | | | | |
| mixture | active | | | | | |
| | material | | | | | |
| | (NCA) | | | | | |
| | Sulfide solid | 13.4 | 13.4 | 13.4 | 13.4 | 13.4 |
| | electrolyte | | | | | |
| | Binder | 0.6 | 0.6 | 0.6 | 0.6 | 0.6 |
| | Conductivity | 1.3 | 1.3 | 1.3 | 1.3 | 1.3 |
| | aid | | | | | |
| Lithium metal secondary | | Lithium | Lithium | Lithium | Lithium | Lithium |
| battery | | metal | metal | metal | metal | metal |
| | | secondary | secondary | secondary | secondary | secondary |
| | | battery D5 | battery D6 | battery D7 | battery d2 | battery d3 |
| Evaluation | First cycle | 2.36 | 2.41 | 2.29 | 2.08 | 2.33 |
| results | reversible | | | | | |
| | capacity | | | | | |
| | [mAh/cm²] | | | | | |
| | Resistance | 21 | 17 | 17 | 298 | 25 |
| | after first | | | | | |
| | charging and | | | | | |
| | discharging | | | | | |
| | [Ωcm²] | | | | | |

According to surface SEM-EDX observation of the composite metal layer A7, it was confirmed that a composite was formed such that gallium surrounded indium particles.

In Examples 5 to 7, regarding the first cycle reversible capacity at 60° C., the lithium metal secondary battery D6 having a composite alloy layer containing a lithium-gallium alloy and a lithium-indium alloy formed from the composite metal layer A6 (Example 6) exhibited the highest value (2.41 mAh/cm²). In addition, regarding the resistance after first charging and discharging at 60° C., the lithium metal secondary batteries D5 to D7 having a composite alloy layer formed from the composite metal layers A5 to A7 had a lower resistance than the lithium metal secondary batteries d2 and d3 having a composite alloy layer formed from the composite metal layers a2 and a3 in which indium was used alone or gallium was used alone.

It was speculated that, when a composite alloy layer formed from a composite metal layer containing a composite formed such that gallium surrounded indium particles was formed near the negative electrode current collector layer, interfacial peeling between the electrolyte layer and the lithium metal layer during lithium desorption was restricted, and thereby the resistance was reduced, and the reversible capacity increased.

While preferable embodiments of the lithium metal secondary battery of the present disclosure have been described, it can be understood by those skilled in the art that modifications can be made without departing from the scope of the claims.

What is claimed is:

1. A lithium metal secondary battery having a negative electrode current collector layer, a composite alloy layer, a lithium metal layer, an electrolyte layer, a positive electrode active material layer, and a positive electrode current collector layer in this order,
wherein the composite alloy layer contains a combination of a lithium-gallium alloy, and a lithium-tin alloy and/or a lithium-indium alloy.

2. The lithium metal secondary battery according to claim 1,
wherein the composite alloy layer contains a lithium-gallium alloy and a lithium-tin alloy, and
wherein the atomic percentage of gallium with respect to a total amount of gallium and tin in the composite alloy layer is 10 to 90 atomic %.

3. The lithium metal secondary battery according to claim 1,
wherein the composite alloy layer contains a lithium-gallium alloy and a lithium-indium alloy, and
wherein the atomic percentage of gallium with respect to a total amount of gallium and indium in the composite alloy layer is 10 to 45 atomic %.
